(19) United States
(12) Patent Application Publication
(10) Pub. No.: US 2005/0185061 A1
(43) Pub. Date: Aug. 25, 2005

(54) Self photographing camera system

(76) Inventor: Andy Baker, Austin, TX (US)

Correspondence Address: Derek R. Van Gilder, 916 Main Street, Bastrop, TX, 78602, US

(21) Appl. No.: 10/784,444

(22) Filed: Feb. 23, 2004

(51) Int. Cl. H04N 7/12; H04N 11/02; H04N 11/04; H04N 5/225; G03B 17/00; F16M 11/14

(52) U.S. Cl. 348/211.4; 348/373; 396/428; 248/183.2

(57) ABSTRACT

This invention accomplishes these and other objectives with a self-photographing camera system having a camera (1) on a swivel base (2, 7, 23) with an electronic receiver (4, 26, 32) for receiving camera-directional input from an electronic transmitter (5, 27, 33) that is positioned on a photograph subject (6) that includes a potentially moving person or object. The electronic receiver is programmable to swivel the camera continuously in a direction that the electronic transmitter is positioned. Swivel direction can be universally horizontal and vertical or optionally horizontal. A wide selection of camera controls by a photograph subject can be included.

### FIELD OF THE INVENTION

This invention relates to a camera which is selectively pointed towards and operated by a subject being photographed.

### RELATION TO PRIOR ART

There are numerous situations for which it is desirable for an intended photography subject to point a remotely positioned camera towards themselves and select objects about them and then for the photography subject to operate the camera selectively in a self-photographing camera system. These situations can include parties, events, police apprehension, news-report photography and commercial monitoring for example.

There are known self-photographing booth apparatuses. Much differently, however, there is no known self-photographing camera system having a camera mount with an electronic receiver which points a camera in a direction of an electronic transmitter that is articulated to be positioned selectively on or proximate a photograph subject for visual and optionally audio recording of individuals, activities, objects and events in a manner taught by this invention.

### SUMMARY OF THE INVENTION

Objects of patentable novelty and utility taught by this invention are to provide a self-photographing camera system which:
automatically points a camera in a direction of a transmitter on a person or object to be photographed;
points the camera in a selected direction prior to entry of the transmitter on the person or other carrier of the transmitter into visual scope of the camera;
allows override direction of the camera; and
can be used for visually recording and optionally for audio recording a wide variety of events, activities and other photograph subjects.

This invention accomplishes these and other objectives with a self-photographing camera system having a swivel base with an electronic receiver for receiving camera-directional input from an electronic transmitter that is positioned on a potentially moving person or object. The electronic receiver is programmable to swivel the camera continuously in a direction that the electronic transmitter is positioned. Swivel direction can be universally horizontal and vertical or optionally horizontal. Light control can be included. Audio recording also can be included.

### BRIEF DESCRIPTION OF DRAWINGS

This invention is described by appended claims in relation to description of a preferred embodiment with reference to the following drawings which are explained briefly as follows:

FIG. 1 is a partially schematic side view of the self-photographing camera system with a swivel base articulated for being attached to desired objects and with a remote electronic transmitter unattached to a photograph object;

FIG. 2 is a partially schematic side view of the self-photographing camera system with a swivel base articulated for being positioned on desired objects and with a remote electronic transmitter in association with the photograph object and showing a side view of a bidirectional swivel motor;

FIG. 3 is a partially schematic side view of the self-photographing camera system with universal swivel without manual override;

FIG. 4 is a partially schematic side view of the self-photographing camera system with universal swivel with manual override;

FIG. 5 is a partially schematic side view of the self-photographing camera system with universal swivel and having digital control of a plurality of camera features by the photograph object;

FIG. 6 is an electronic diagram of an electronic transmitter that can be used for transmitting direction control of the camera;

FIG. 7 is an electronic diagram of an electronic receiver that can be used for receiving direction control for the camera; and

FIG. 8 is a schematic representation of a digital universal transmitter on a photograph subject in digital-control communication with a digital universal receiver on a camera for digital control of a plurality of features of the camera.

### DESCRIPTION OF PREFERRED EMBODIMENT

A description of the preferred embodiment of this invention follows a list of numbered items which designate its features with the same numbers on its drawings and, in parentheses throughout its description and patent claims.

1. Camera 21.

2. Swivel base

3. Swivel motor

4. Electronic receiver

5. Electronic transmitter

6. Photograph subject

7. Bidirectional swivel base

8. Horizontal swivel motor

9. Manual direction controller

10. 555 timer IC

11. 5 k ohm resistor

12. 2.2 k ohm resistor

13. 0.0047-microfarad capacitor

14. Quad comparator IC

15. 10 k ohm resistor

16. Source voltage

17. Ground

18. 33 k ohm resistor

19. PNP transistor

20. SPDT relay

21. Source voltage

22. Ground

23. Universal swivel base

24. Horizontal swivel yoke

25. Vertical swivel motor

26. Universal electronic receiver

27. Universal electronic transmitter

28. Manual universal controller

29. Universal knob

30. Zoom controller

31. Audio controller

32. Digital universal receiver

33. Digital universal transmitter

34. Digital control units

35. Control knobs

36. Receiver digital units

37. Transmitter circuit lines

38. Transmission processor

39. Receiver processor

40. Receiver circuit lines

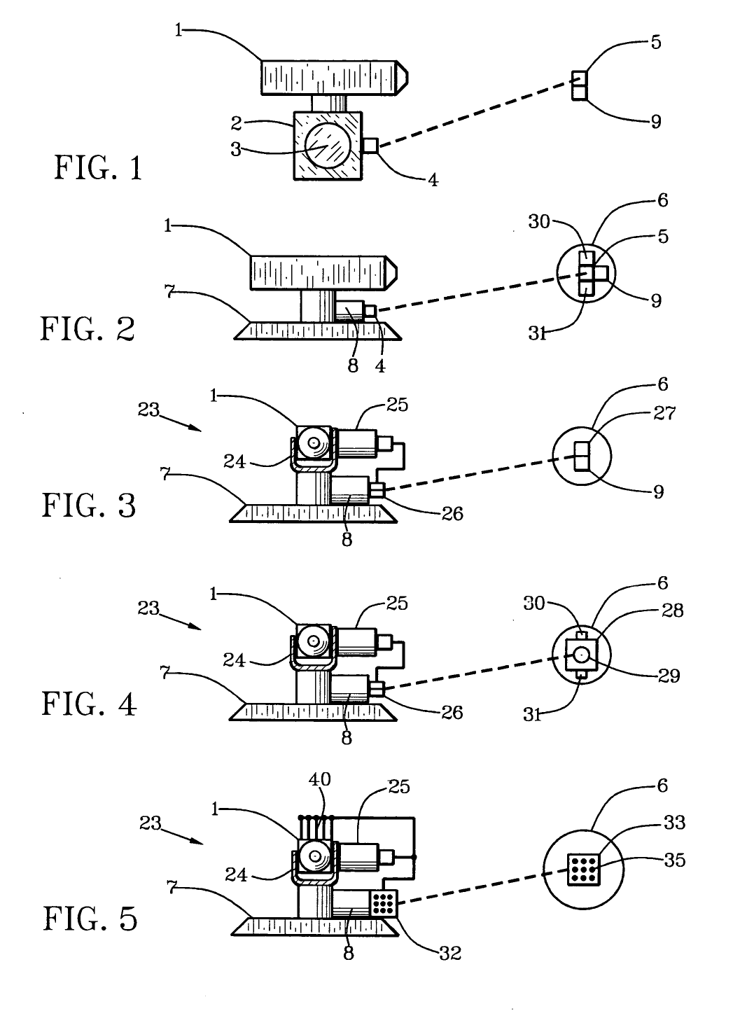

Referring to FIGS. 1-2, a camera (1) is positioned directionally rotational on a swivel base (2) with at least one swivel motor (3) having camera-swivel communication intermediate the camera (1) and the swivel base (2) through at least one electronic receiver (4) in electronic-control communication with the swivel motor (3) for directionally operating the camera (1) with at least one electronic transmitter (5) in electronic communication with the electronic receiver (4). The electronic transmitter (5) is articulated for being positioned proximate a photograph subject (6) for electronic communication of camera-operational direction to the electronic receiver (4) for operating the camera (1) selectively.

The swivel base (2) includes a bidirectional swivel base (7). The swivel motor (3) includes a horizontal swivel motor (8) that is articulated for swiveling the camera (1) bidirectionally horizontal. The electronic transmitter (5) includes transmission capability for transmitting rotational direction and rotational positioning of the camera (1) on the swivel base (2).

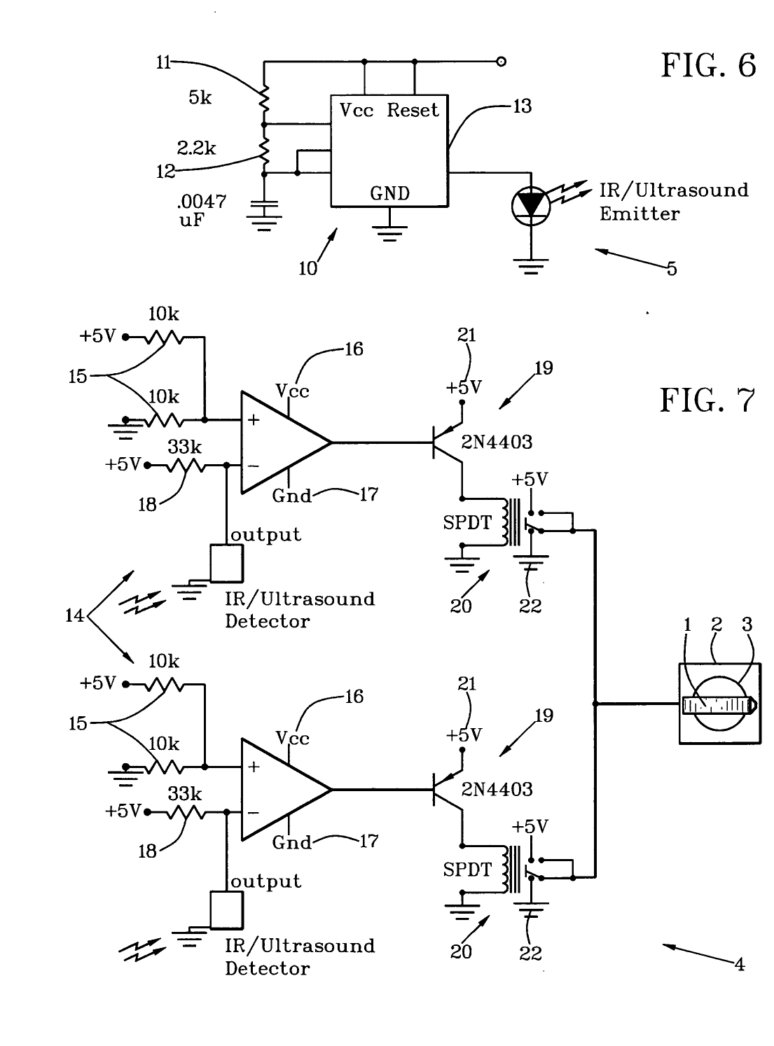

Referring to FIGS. 1-2 and 6-7, for a preferred embodiment of the self-photographing camera system, the electronic transmitter (5), diagramed in FIG. 6; has a transmitter circuit that is timed to output an oscillating waveform. Resistors and a capacitor control frequency output of a 555 timer IC (10). By using a 5 k ohm resistor (11) and a 2.2 k ohm resistor (12) in conjunction with a 0.0047-microfarad capacitor (13), a desired frequency of 32.59 kilohertz can be achieved. These values are changeable, but at 32.59 kilohertz, a positive time interval of 0.02345 milliseconds and a negative time interval of 0.00717 milliseconds are achieved for a duty cycle of 76.6%. When multiple units are to be used in close proximity, a different frequency on each unit is desirable to negate any errors that the electronic receivers (4) may have in tracking targets.

A receiver circuit for the electronic receiver (4), diagramed in FIG. 7, is based on a Quad Comparator IC (14). Positive input of the Quad Comparator IC (14) is used as a reference voltage. Two 10 K ohm resistors (15) tied to source voltage (16) and to ground (17) respectively reduce supply voltage to one-half at the positive input of the Quad Comparator IC (14). A 33 k ohm resistor (18) at the negative input is determined by two factors. One is impedance value of the detector. The other is voltage drop produced by the detector. This allows the negative input to drop below the reference voltage for enabling the output logic of the Quad Comparator IC (14). The output of the detector is fed to the base of a PNP transistor (19). The collector of the PNP transistor (19) is connected to an SPDT relay (20) while its emitter is tied to source voltage (21). When the entire circuit is energized, both relays are latched to ground (22). When one of the detectors receives a signal from the electronic transmitter (5), the Quad Comparator IC (14) outputs to the PNP transistor (19) for triggering the relay to latch to the source voltage. This in turn feeds the swivel motor (3) to rotate. The relays, when latched to the source voltage can reverse polarity to the swivel motor (3). This allows clockwise and counterclockwise rotation of the swivel motor (3). The swivel motor (3) rotates the detectors and their load related to the camera (1) in a direction of the electronic transmitter (5). When rotation of the detectors is beyond the electronic transmitter (5), the relays latch back to the ground and stop rotation of the swivel motor (3). The detectors are placed at angles away from one another to create an envelope of non-detectable space between them. Thus, the circuit always keeps the electronic transmitter (5) between the two detectors.

Referring to FIGS. 1-4, the transmission capability of the electronic transmitter (5) to transmit rotational direction and rotational positioning of the camera (1) on the swivel base (2) includes predeterminedly fixed rotating and positioning of the camera (1) on the swivel base (2) automatically in accordance with horizontally rotational distance of the electronic transmitter (5) from the swivel base (2).

The transmission capability of the electronic transmitter (5) to transmit rotational direction and rotational positioning of the camera (1) on the swivel base (2) includes manual control of rotating and positioning the camera (1) on the swivel base (2).

The manual control of rotating and positioning the camera (1) on the swivel base (2) includes override of the fixed rotating and positioning of the camera (1) on the swivel base (2).

A manual direction controller (9) can be positioned on the electronic transmitter (5) for electronic communication to the electronic receiver (4) for the manual control of rotating and positioning of the camera (1) on the swivel base (2).

The swivel base (2) can include a universal swivel base (23) with the camera (1) positioned rotationally on an axis intermediate arms of a horizontal-swivel yoke (24) that is rotational horizontally on the bidirectional swivel base (7). The swivel motor (3) can include the horizontal swivel motor (8) that is articulated for swiveling the camera (1) horizontally by swiveling the horizontal-swivel yoke (24) horizontally. The horizontal-swivel yoke (24) can include a vertical swivel motor (25) that is articulated and positioned for swiveling the camera (1) vertically intermediate the arms of the horizontal-swivel yoke (24).

For the universal swivel base (23), the electronic receiver (4) can include a universal electronic receiver (26). The universal electronic receiver (26) can have horizontally rotational communication with the horizontal swivel motor (8) and can have vertically rotational communication with the vertical swivel motor (25). The electronic transmitter (5) can include a universal electronic transmitter (27) in electronic communication with the universal electronic receiver (26) for transmitting universally swiveling commands from the universal electronic transmitter (27) that is articulated for being positioned selectively proximate the photograph subject (6).

The transmission capability of the universal electronic transmitter (27) to transmit rotational direction and rotational positioning of the camera (1) on the universal swivel base (23) can include dedicated universally rotating and positioning of the camera (1) on the universal swivel base (23) automatically in accordance with universally changeable distance of the universal electronic transmitter (27) from the universal electronic receiver (26).

The transmission capability of the universal electronic transmitter (27) to transmit rotational direction and rotational positioning of the camera (1) on the universal swivel base (23) can include manual control of rotating and positioning the camera (1) on the universal swivel base (23).

The manual control of rotating and positioning the camera (1) on the universal swivel base (23) can include override of the dedicated rotating and positioning of the camera (1) on the universal swivel base (23).

The universal electronic transmitter (27) can include a manual universal controller (28) for electronic communication to the universal electronic receiver (26) for the manual control of universally rotating and positioning of the camera (1) on the universal swivel base (23).

The manual universal controller (28) can include a universal knob (29) that is rotational for horizontally rotational control and is four-directionally slidable for vertically rotational control.

Referring to FIGS. 1-5, the camera (1) can include lenses having zoom-nearness adjustment. The electronic receiver (4) can include electronic control of the zoom-nearness adjustment. The electronic transmitter (5) can include electronic communication of the zoom adjustment to the electronic receiver (4) and a zoom controller (30) can be positioned on the electronic transmitter (5) for manual operation by the photograph subject (6).

The camera (1) can include audio recording capability. The electronic receiver (4) can include electronic control of the audio recording capability. The electronic transmitter (5) can include electronic communication of the audio recording capability to the electronic receiver (4) and an audio controller (31) can be positioned on the electronic transmitter (5) for manual operation by the photograph subject (6).

The camera (1) can include lenses having zoom adjustment. The universal electronic receiver (26) can include electronic control of the zoom adjustment. The universal electronic transmitter (27) can include electronic communication of the zoom adjustment to the universal electronic receiver (26) and the zoom controller (30) can be positioned on the universal electronic transmitter (27) for manual operation by the photograph subject (6).

The camera (1) can include audio recording capability. The universal electronic receiver (26) can include electronic control of the audio recording capability. The universal electronic transmitter (27) can include electronic communication of the audio recording capability to the universal electronic receiver (26) and the audio controller (31) can be positioned on the universal electronic transmitter (27) for manual operation by the photograph subject (6).

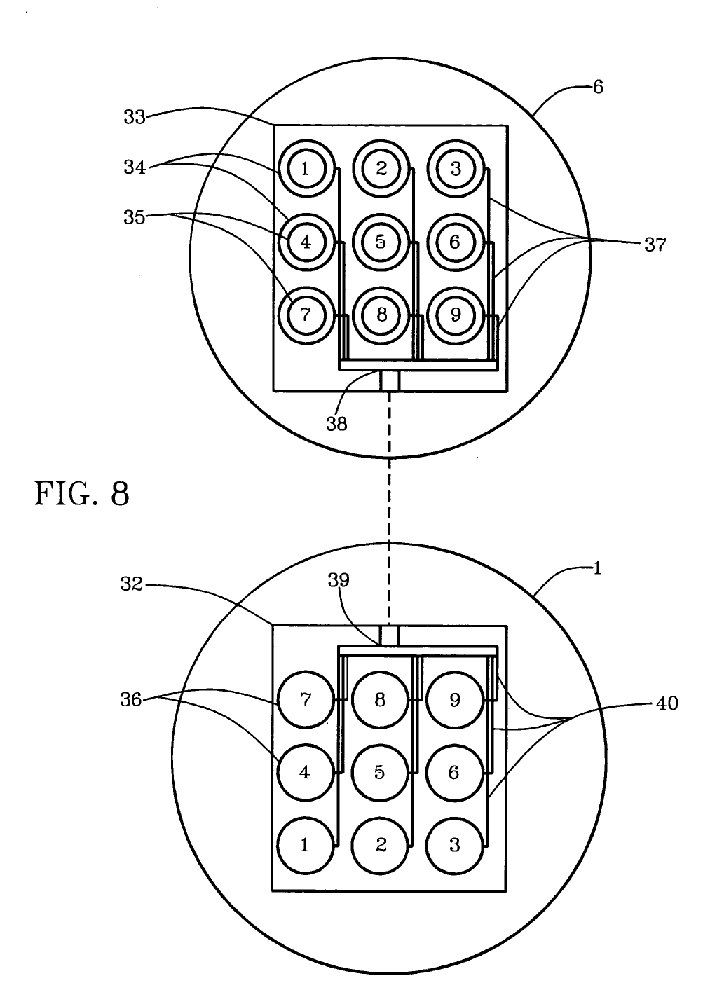

Referring to FIGS. 5 and 8, the universal swivel base (23) with the horizontal-swivel yoke (24) can include a digital universal receiver (32) in electronic-control communication with the horizontal swivel motor (8) for rotating the horizontal-swivel yoke (24) and the camera (1) horizontally. The digital universal receiver (32) can be in electronic-control communication with the vertical swivel motor (25) for rotating the camera (1) vertically.

A digital universal transmitter (33) can be in predetermined electronic control communication with the digital universal receiver (32), the digital universal transmitter (33) being articulated for being positioned proximate the photograph subject (6) for electronic communication of camera-operational direction to the digital universal receiver (32) digitally for operating the camera (1) selectively.

The digital universal transmitter (33) can include a plurality of digital control units (34) that are operable manually with control knobs (35) that are numbered for operating correspondingly numbered receiver digital units (36) on the digital universal receiver (32) for operating controllably operable features of the camera (1) remotely by the photograph subject (6).

The digital control units (34) are articulated to transmit digital control data provided manually through the control knobs (35) for transmission through transmitter circuit lines (37) to a transmission processor (38) for transmission to the digital universal receiver (32). The digital universal receiver (32) is articulated to receive the transmission from the digital control units (34) and to transmit the digital control data to corresponding controllably operable camera features for operating the controllably operable features of the camera (1) remotely by the photograph subject (6).

The digital universal receiver (32) is articulated to receive the transmission from the digital control units (34) through a receiver processor (39) for transmission through receiver circuit lines (40) to the receiver digital units (36) of corresponding controllably operable camera features for operating the controllably operable features of the camera (1) remotely by the photograph subject (6).

The controllably operable features of the cam era (1) are selected from a class of cam-era-control features which include camera zoom, sound, light, contrast, horizontal swivel, vertical swivel, switching, speed and photograph coloring.

A new and useful self-photographing cam-era system having been described, all such foreseeable modifications, adaptations, substitutions of equivalents, mathematical possibilities of combinations of parts, pluralities of parts, applications and forms thereof as described by the following claims and not precluded by prior art are included in this invention.

1. A self-photographing camera system comprising:
a camera (1) on a swivel base (2);
at least one swivel motor (3) proximate the swivel base (2);
the swivel motor (3) having camera-swivel communication intermediate the camera (1) and the swivel base (2);
at least one electronic receiver (4) in electronic-control communication with the swivel motor (3) for operating the camera (1);
at least one electronic transmitter (5) in electronic communication with the electronic receiver (4); and
the electronic transmitter (5) being articulated for being positioned proximate a photograph subject (6) for electronic communication of camera-operational direction to the electronic receiver (4) for operating the camera (1) selectively.

2. The self-photographing camera system of claim 1 wherein:
the swivel base (2) includes a bidirectional swivel base (7); and
the swivel motor (3) includes a horizontal swivel motor (8) that is articulated for swiveling the camera (1) bidirectionally horizontal with the horizontal swivel motor (8).

3. The self-photographing camera system of claim 2 wherein:
the electronic transmitter (5) includes transmission capability for transmitting rotational direction and rotational positioning of the camera (1) on the swivel base (2).

4. The self-photographing camera system of claim 3 wherein:
the transmission capability of the electronic transmitter (5) to transmit rotational direction and rotational positioning of the camera (1) on the swivel base (2) includes predeterminedly fixed rotating and positioning of the camera (1) on the swivel base (2) automatically in accordance with horizontally rotational distance of the electronic transmitter (5) from the swivel base (2).

5. The self-photographing camera system of claim 3 wherein:
the transmission capability of the electronic transmitter (5) to transmit rotational direction and rotational positioning of the camera (1) on the swivel base (2) includes manual control of rotating and positioning the camera (1) on the swivel base (2).

6. The self-photographing camera system of claim 5 wherein:
the manual control of rotating and positioning the camera (1) on the swivel base (2) includes override of the fixed rotating and positioning of the camera (1) on the swivel base (2).

7. The self-photographing camera system of claim 5 and further comprising:
a manual direction controller (9) on the electronic transmitter (5) for electronic communication to the electronic receiver (4) for the manual control of rotating and positioning of the camera (1) on the swivel base (2).

8. The self-photographing camera system of claim 1 wherein:
the swivel base (2) includes a universal swivel base (23);
the camera (1) is positioned rotationally on an axis intermediate arms of a horizontal-swivel yoke (24) that is rotational horizontally on the bidirectional swivel base (7);
the swivel motor (3) includes the horizontal swivel motor (8) that is articulated for swiveling the camera (1) horizontally by swiveling the horizontal-swivel yoke (24) horizontally;
the horizontal-swivel yoke (24) includes a vertical swivel motor (25) that is articulated and positioned for swiveling the camera (1) vertically intermediate the arms of the horizontal-swivel yoke (24);
the electronic receiver (4) includes a universal electronic receiver (26);
the universal electronic receiver (26) having horizontally rotational communication with the horizontal swivel motor (8) and having vertically rotational communication with the vertical swivel motor (25); and
the electronic transmitter (5) includes a universal electronic transmitter (27) in electronic communication with the universal electronic receiver (26) for transmitting universally swiveling commands to the universal electronic transmitter (27) that is articulated for being positioned selectively proximate the photograph subject (6).

9. The self-photographing camera system of claim 8 wherein:
the transmission capability of the universal electronic transmitter (27) to transmit rotational direction and rotational positioning of the camera (1) on the universal swivel base (23) includes dedicated universally rotating and positioning of the camera (1) on the universal swivel base (23) automatically in accordance with universally changeable distance of the universal electronic transmitter (27) from the universal electronic receiver (26).

10. The self-photographing camera system of claim 8 wherein:
the transmission capability of the universal electronic transmitter (27) to transmit rotational direction and rotational positioning of the camera (1) on the universal swivel base (23) includes manual control of rotating and positioning the camera (1) on the universal swivel base (23).

11. The self-photographing camera system of claim 9 wherein:
the manual control of rotating and positioning the camera (1) on the universal swivel base (23) includes override of the dedicated rotating and positioning of the camera (1) on the universal swivel base (23).

12. The self-photographing camera system of claim 11 and further comprising:
a manual universal controller (28) on the universal electronic transmitter (27) for electronic communication to the universal electronic receiver (26) for the manual control of universally rotating and positioning of the camera (1) on the universal swivel base (23).

13. The self-photographing camera system of claim 12 wherein:
the manual universal controller (28) includes a universal knob (29) that is rotational for horizontally rotational control and four-directionally slidable for vertically rotational control.

14. The self-photographing camera system of claim wherein:
the camera (1) includes lenses having zoom adjustment;
the electronic receiver (4) includes electronic control of the zoom adjustment;
the electronic transmitter (5) includes electronic communication of the zoom adjustment to the electronic receiver (4); and
a zoom controller (30) is positioned on the electronic transmitter (5) for manual operation by the photograph subject (6).

15. The self-photographing camera system of claim 1 wherein:
the camera (1) includes audio recording capability;
the electronic receiver (4) includes electronic control of the audio recording capability;
the electronic transmitter (5) includes electronic communication of the audio recording capability to the electronic receiver (4); and
an audio controller (31) is positioned on the electronic transmitter (5) for manual operation by the photograph subject (6).

16. The self-photographing camera system of claim 8 wherein:
the camera (1) includes lenses having zoom adjustment;
the universal electronic receiver (26) includes electronic control of the zoom adjustment;
the universal electronic transmitter (27) includes electronic communication of the zoom adjustment to the universal electronic receiver (26); and
a zoom controller (30) is positioned on the universal electronic transmitter (27) for manual operation by the photograph subject (6).

17. The self-photographing camera system of claim 8 wherein:
the camera (1) includes audio recording capability;
the universal electronic receiver (26) includes electronic control of the audio recording capability;
the universal electronic transmitter (27) includes electronic communication of the audio recording capability to the universal electronic receiver (26); and
an audio controller (31) is positioned on the universal electronic transmitter (27) for manual operation by the photograph subject (6).

18. A self-photographing camera system comprising:
a universal swivel base (23) for the camera (1) that is positioned rotationally on an axis intermediate arms of the horizontal-swivel yoke (24);
a vertical swivel motor (25) articulated and positioned on the horizontal-swivel yoke (24) for rotating the camera (1) vertically;
the horizontal-swivel yoke (24) being rotational horizontally on the bidirectional swivel base (7);
the horizontal swivel motor (8) on the bidirectional swivel base (7);
the universal electronic receiver (26) in electronic-control communication with the horizontal swivel motor (8) for rotating the horizontal-swivel yoke (24) and the camera (1) horizontally;
the universal electronic receiver (26) being in electronic-control communication with the vertical swivel motor (25) for rotating the camera (1) vertically;
the universal electronic transmitter (27) being in predetermined electronic control communication with the universal electronic receiver (26);
the universal electronic transmitter (27) being articulated for being positioned proximate the photograph subject (6) for electronic communication of camera-operational direction to the universal electronic receiver (26) for operating the camera (1) selectively;
the universal electronic transmitter (27) includes the universal electronic transmitter (27) being in electronic communication with the universal electronic receiver (26) for transmitting universally swiveling commands to the universal electronic receiver (26);
the transmission capability of the universal electronic transmitter (27) to transmit rotational direction and rotational positioning of the camera (1) on the universal swivel base (23) includes manual control of rotating and positioning the camera (1) on the universal swivel base (23);
the manual control of rotating and positioning the camera (1) on the universal swivel base (23) includes override of the dedicated rotating and positioning of the camera (1) on the universal swivel base (23);
a manual universal controller (28) on the universal electronic transmitter (27) for electronic communication to the universal electronic receiver (26) for the manual control of universally rotating and positioning of the camera (1) on the universal swivel base (23);
the manual universal controller (28) including universal knob (29) that is rotational for horizontally rotational control and four-directionally slidable for vertically rotational control;
the camera (1) includes lenses having zoom adjustment;
the universal electronic receiver (26) includes electronic control of the zoom adjustment;
the universal electronic transmitter (27) includes electronic communication of the zoom adjustment to the electronic receiver (4); and
a zoom controller (30) is positioned on the electronic transmitter (5) for manual operation by the photograph subject (6).

19. The self-photographing camera system of claim 18 wherein:
the camera (1) includes audio recording capability;
the universal electronic receiver (26) includes electronic control of the audio recording capability;
the universal electronic transmitter (27) includes electronic control communication of the audio recording capability to the electronic receiver (4); and
the audio controller (31) is positioned on the universal electronic transmitter (27) for manual operation by the photograph subject (6).

20. The self-photographing camera system of claim 18 wherein:
the camera (1) includes lenses having zoom adjustment;
the universal electronic receiver (26) includes electronic control of the zoom adjustment;
the universal electronic transmitter (27) includes electronic communication of the zoom adjustment to the universal electronic receiver (26); and
a zoom controller (30) is positioned on the universal electronic transmitter (27) for manual operation by the photograph subject (6).

21. A self-photographing camera system comprising:
a universal swivel base (23) having the horizontal-swivel yoke (24);
the camera (1) being positioned rotationally on an axis intermediate arms of the horizontal-swivel yoke (24);
a vertical swivel motor (25) articulated and positioned on the horizontal-swivel yoke (24) for rotating the camera (1) vertically;
the horizontal-swivel yoke (24) being rotational horizontally on the bidirectional swivel base (7) with the horizontal swivel motor (8) on the bidirectional swivel base (7);
a digital universal receiver (32) in electronic-control communication with the horizontal swivel motor (8) for rotating the horizontal-swivel yoke (24) and the camera (1) horizontally;
the digital universal receiver (32) being in electronic-control communication with the vertical swivel motor (25) for rotating the camera (1) vertically;
a digital universal transmitter (33) being in predetermined electronic control communication with the digital universal receiver (32); and
the digital universal transmitter (33) being articulated for being positioned proximate the photograph subject (6) for electronic communication of camera-operational direction to the digital universal receiver (32) digitally for operating the camera (1) selectively.

22. The self-photographing camera system of claim 21 wherein:
the digital universal transmitter (33) includes a plurality of digital control units (34) that are operable manually with control knobs (35) that are numbered for operating correspondingly numbered receiver digital units (36) on the digital universal receiver (32) for operating controllably operable features of the camera (1) remotely by the photograph subject (6).

23. The self-photographing camera system of claim 22 wherein:
the digital control units (34) are articulated to transmit digital control data provided manually through the control knobs (35) for transmission through transmitter circuit lines (37) to a transmission processor (38) for transmission to the digital universal receiver (32);
the digital universal receiver (32) is articulated to receive the transmission from the digital control units (34) and to transmit the digital control data to corresponding controllably operable camera features for operating the controllably operable features of the camera (1) remotely by the photograph subject (6).

24. The self-photographing camera system of claim 23 wherein:
the digital universal receiver (32) is articulated to receive the transmission from the digital control units (34) through a receiver processor (39) for transmission through receiver circuit lines (40) to the receiver digital units (36) of corresponding controllably operable camera features for operating the controllably operable features of the camera (1) remotely by the photograph subject (6).

25. The self-photographing camera system of claim 24 wherein:
the controllably operable features of the camera (1) are selected from a class of camera-control features which include camera zoom, sound, light, contrast, horizontal swivel, vertical swivel, switching, speed and photograph coloring.
